(19) United States
(12) Patent Application Publication
(10) Pub. No.: US 2026/0351647 A1
(43) Pub. Date: Nov. 5, 2026

(54) REGENERATIVE SYSTEM

(71) Applicant: ARCO FC S.R.L, Granarolo Dell'Emilia (Bologna) (IT)

(72) Inventors: Giovanni CUFALO, Palermo (IT); Angelo D'ANZI, Medicina (Bologna) (IT); Nicholas LOI, Civitavecchia RM (IT)

(21) Appl. No.: 19/488,526

(22) PCT Filed: May 31, 2024
(86) PCT No.: PCT/IB2024/055332

§ 371 Date: Nov. 26, 2025

(30) Foreign Application Priority Data
May 31, 2023 (IT) 102023000011013

(51) Int. Cl. H01M 8/18; H01M 8/0438; H01M 8/0444; H01M 16/00

(52) U.S. Cl. CPC H01M 8/186; H01M 8/04425; H01M 8/04447; H01M 8/04455; H01M 16/003

(57) ABSTRACT

Described is a regenerative system (1) comprising:
one or more fuel cells (2) comprising a plurality of individual bipolar cells stacked with each other (4) which form a stack, an inlet (6) for a fuel and an inlet (7) for an oxidiser;
one or more electrolysers (3) comprising a plurality of bipolar cells (5) positioned in series with each other, one or more inlets (12) for the electrolyte, one outlet (13) for a reaction product, another outlet (14) for the other reaction product;
a coupling head (15) interposed between the fuel cell (2) and the electrolyser (3) which are mounted on the coupling head (15) on opposite sides of it;
one or more shells (20, 23), housing the electrolyser (3) and the fuel cell (2), sealed around them in such a way that one or more free spaces are delimited, which can be filled with one or more pressurised fluids.

### TECHNICAL FIELD

This invention relates to a regenerative fuel cell system.

A regenerative fuel cell system is a system which can operate in two ways: as a fuel cell (FC) or as an electrolyser (EL).

### BACKGROUND ART

A regenerative fuel cell system is a system which can operate in two ways: as a fuel cell (FC) or as an electrolyser (EL).

Schematically, in the “electrolyser” mode the water is split into hydrogen and gaseous oxygen, providing electricity to the stack, whilst in the “fuel cell” mode the hydrogen and oxygen react in a controlled manner, generating water and electricity.

In the electrolyser mode, the water supplied is split into hydrogen and oxygen using the electricity supplied. The oxygen generated can be used as an oxidising gas in the fuel cell of the same system or in other applications, whilst the hydrogen can be used as a fuel in the same system or stored and used for other applications. The regenerative fuel cell systems are characterised by high power density and specific energy, high efficiency and have potential applications in sectors such as spacecraft, satellites, submarines, aircraft or power supply systems in remote areas, when there is a variable input of energy, for example solar or wind, and a local storage of it is critical.

These systems must be easily portable in order to obtain the expected power density levels; on the other hand, the components of the regenerative systems may not be optimised in terms of mass.

For example, the accumulation of pressurised gas, which requires the use of compressors and storage tanks, has a large impact on the “BOP” (Balance Of Plant) of the system and, therefore, on the dimensions, on the mass and on the energy consumption of the regenerative systems.

Patent document U.S. Pat. No. 6,833,207 illustrates a regenerative fuel cell system comprising an “electrolyser” portion and a “fuel cell” portion grouped together and separated by a separating head in common which puts in communication the two portions. The fuel cell portion and the electrolyser portion operate preferably in juxtaposition which does not make easy the optimum control of the temperature and pressure operating conditions, operating at a same pressure, which is not necessarily the optimum pressure for both, and the gases are stored in suitable tanks.

Another drawback of prior art regenerative systems is the management of the heat which affects the performance of the system. In the fuel cells, a part of the energy is converted into heat and the removal of heat is essential for the proper operation of the cells. The cooling of the fuel cells can be divided into two main categories: air cooling and liquid cooling. Air-cooled fuel cells are more preferably used in applications where the nominal power is not high, usually less than 5 kW, whilst liquid cooling is a common method for removing the residual heat from the stack of fuel cells with a higher power (>5 kW).

Currently, the liquid cooling is used in many cases in fuel cells because, for example, the water or the aqueous solutions of ethylene glycol, have a relatively high thermal conductivity and a high thermal capacity specific to standard conditions. However, a large amount of energy is consumed to guarantee the circulation of the liquid coolant.

In the sector of regenerative fuel cell systems the need is felt for systems with an even higher energy density, which are efficient and compact.

In this context, the aim is to propose a regenerative fuel cell system with high performance levels that is capable of overcoming at least some of the drawbacks of the prior art and of meeting the above-mentioned need.

### AIM OF THE INVENTION

In particular, the aim of the invention is to provide a compact and efficient regenerative fuel cell system.

This aim is achieved by a regenerative system comprising the technical features described in one or more of the accompanying claims. The dependent claims correspond to possible different embodiments of the invention.

According to a first aspect, this invention relates to a regenerative system comprising a fuel cell and an electrolyser coupled to each other.

The fuel cell preferably comprises a plurality of individual cells which form a stack.

The electrolyser preferably comprises a plurality of individual electrolysis cells which form a stack.

The fuel cell may comprise a plurality of fuel cells.

The electrolyser may comprise a plurality of electrolysers.

The fuel cell, the electrolyser and their operation are described only insofar as necessary for understanding this invention, since they are of substantially known type.

The fuel cell has an anode side, a cathode side, an inlet for a fuel, preferably hydrogen and an inlet for an oxidiser, preferably oxygen.

The fuel cell has an outlet for any outlet gas on the cathode side, for example oxygen which has not reacted or a gas rich in nitrogen if the cell is supplied with air.

The fuel cell has an outlet for any exhaust gas on the anode side, for example hydrogen which has not reacted and/or water vapour due to water which on the cathode side has passed through the membrane of the fuel cell.

The electrolyser has an anode, a cathode, at least one inlet for an electrolyte, an outlet for a first reaction product, for example oxygen, an outlet for a second reaction product, for example hydrogen.

Based on the constructional choices, the electrolyser may have an inlet for the electrolyte both from the cathode side and from the anode side.

The regenerative system comprises a coupling head interposed between the stack of the fuel cell and the stack of the electrolyser.

Preferably, the coupling head is in common with the two stacks and can keep them separated both electrically and fluid dynamically.

The fuel cell and the electrolyser are mounted on the coupling head on opposite sides relative to it.

The reagents of the regenerative system enter the head and the reaction products of the regenerative system leave the head.

The regenerative system comprises a first shell inside of which the electrolyser is inserted.

The anode, the cathode, the inlet of the electrolyte and at least the outlet of the first reaction product are in communication with the outside of the first shell.

The first shell is closed in a sealed fashion around the electrolyser in such a way as to delimit, at least partly, a space in which a gas preferably under pressure can be inserted.

Preferably, the anode, the cathode, the inlet of the electrolyte and at least the outlet of the first reaction product are in communication with the outside of the first shell closed in a sealed fashion through the first shell, for example by means of respective conduits passing through the first shell.

Advantageously, in this way, the coupling of the electrolyser with the fuel cell is particularly compact since the coupling head is not obstructed, at least, by the inlet of the electrolyte and by the outlet of the first reaction product of the electrolyser and may be easily coupled to the fuel cell.

The outlet of the second reaction product of the electrolyser may be in communication with the outside of the first shell through the first shell, for example by a conduit passing through the first shell.

Advantageously, the outlet of the second reaction product of the electrolyser may be put in communication with the inside of the first shell by means of the coupling head.

In any case, advantageously, the coupling head is not in parts even occupied by the outlet of the second reaction product which therefore does not obstruct the coupling with the fuel cell.

The gas, to which reference is hereinafter made without thereby limiting the scope of the invention, provides a general example of a fluid which can be inserted in the space between the electrolyser and the first shell.

Preferably, the gas is inert and it is nitrogen.

Preferably, the pressure of the gas in the space between the electrolyser and first shell is greater than the pressure at which the electrolyser is operated.

In that way, any gas or liquid leaks from the electrolyser outside the regenerative system are also blocked.

Preferably, the pressure of the gas in the space between the electrolyser and the first shell is greater than 60 bar.

By filling the space between the electrolyser and the first shell with a gas under pressure it is possible to use or produce gas at high pressures without the electrolyser being designed to operate at these pressures, in effect being subjected to a relative pressure which depends, in particular, on the pressure between the stack and the first shell and on the operating pressure.

The stack of individual electrolysis cells can therefore be constructed with common and less costly material than that necessary for high pressure production.

The system also offers the possibility of producing compressed hydrogen through a “low” symmetrical pressure between the anode side and the cathode side, avoiding gas permeation phenomena but without mechanical compressors and without particular components suitable for producing high pressure gas.

In this way, it is also possible to increase the power density of the regenerative system.

According to an embodiment, the pressure of the gas in the space between the electrolyser and the first shell may be less than the pressure at which the electrolyser is operated.

Advantageously, in that case, it is possible to limit the gas or liquid leaks from the electrolyser outside the regenerative system.

These leaks can in effect be identified either inside the electrolyser or in the space between the first shell and the electrolyser before reaching the outside environment for example due to a modification of the composition of the gas in the space between the electrolyser and the first shell.

Any leaks of the electrolyser are diluted by the inert gas and therefore any escape from the first shell will also be greatly reduced, avoiding dangerous situations and potentially explosive areas.

Preferably, the regenerative system comprises a second shell in which the fuel cell is inserted.

The anode side, the cathode side, the inlet for the fuel, the inlet for the oxidiser are in communication with the outside of the second shell.

Preferably, the inlet for the oxidiser is in communication with the outside of the second shell through the second shell for example by means of a conduit passing through the second shell.

Preferably, the anode side of the fuel cell is in communication with the outside of the second shell through the second shell for example by means of a terminal.

The second shell is closed in a sealed fashion around the fuel cell in such a way that a space is delimited, at least partly, between the second shell and the fuel cell.

Preferably, the regenerative system comprises a gas in the second space.

Preferably, the gas in the second space is an inert gas.

The gas in the second space exemplifies a fluid which fills the second space and reference is made below to the gas or to the inert gas without limiting the scope of the invention.

The hydrogen produced by the electrolyser may be used as a fuel in the anode side of the fuel cell.

The hydrogen generated by the electrolysers is usually moist.

Advantageously, the fluid present in the space delimited by the second shell around the fuel cell can prevent a flooding of the flow channels of the fuel cell due to the moist hydrogen generated during the electrolyser mode.

Advantageously, an inert gas present in the space inside the second shell may act as a coolant for the individual fuel cells of the stack.

Preferably, the regenerative system comprises a system for recirculating inert gas.

Advantageously, the presence of a shell around the electrolyser and a shell around the fuel cell allows both to work at the relative optimum pressures with high efficiency and with specific dimensions suitable for applications which require small spaces and not high weights.

According to alternative embodiments, the pressure of the gas in the space between the fuel cell and the second shell may be less than or greater than the pressure at which the fuel cell is operated.

In effect, the pressure has a significant impact on the processes inside a fuel cell and/or an electrolyser; some effects of the pressure in general are:
effect on the diffusion of reagents: an increase in the pressure may increase the speed of diffusion of the reagents inside the cell. This means that the oxidiser (for example, oxygen) and the fuel (for example, hydrogen) can reach the electrodes faster, thus improving efficiency and reaction speed;
effect on the ohmic resistance: the pressure may affect the ohmic resistance inside the cell. The ohmic resistance is due to the resistance of the materials used in the cell and to the passage of the current through them. An increase in pressure may reduce the ohmic resistance, allowing a greater efficiency in the transfer of electrons through the cell;
effect on the electrode reaction: the pressure may affect the kinetics of the electrochemical reactions at the electrodes. For example, an increase in the pressure may increase the speed of the oxidisation reactions of the fuel and reduction of the oxidiser at the electrodes, thereby improving the power generated by the cell;
effect on the gas saturation: by increasing the pressure, it is possible to increase the quantity of gas that can be absorbed by the electrolyte or by the pores of the electrode. this may increase the transport capacity of reagents and products through electrolyte, improving the overall efficiency of the cell.

An increase in the pressure inside the cell can result in additional costs in terms of more resistant construction materials and sealing systems suitable for managing the higher pressures. Moreover, the optimisation of the pressure conditions requires a careful balancing of other parameters, such as the temperature and the composition of the reagents, in order to maximise the overall performance of the cell.

Advantageously, as mentioned, the use of pressurised shells avoids the above-mentioned drawbacks, allowing the cells to operate at a relative pressure which may correspond to the normal operating pressure.

With regard to electrolysers, the gas pressures affect the storage of the gases produced. The advantage of having high pressure electrolysers is that of a better storage for future applications which require a predetermined compression of the hydrogen, thereby avoiding the mechanical compression step at the outlet of the electrolyser.

Preferably, the regenerative system comprises a flange positioned between the electrolyser and the fuel cell.

Preferably, the first shell which surrounds the electrolyser is fixed in a sealed fashion on the flange.

Preferably, the second shell which surrounds the fuel cell is fixed in a sealed fashion on the flange.

Preferably, the first shell and the second shell, joined to the flange, define a casing, closed in a sealed fashion, of the regenerative system.

The coupling head between the electrolyser and the fuel cell is positioned inside the casing of the regenerative system.

Preferably, the coupling head between the electrolyser and the fuel cell is positioned inside the first shell of the electrolyser.

Preferably, the coupling head between electrolyser and fuel cell is positioned on the same side of the electrolyser with respect to the flange.

Preferably, the inlet of the fuel of the fuel cell is in communication with the outside of the casing of the regenerative system through the first shell, for example by means of a respective conduit passing through the first shell.

Preferably, the cathode side of the fuel cell is in communication with the outside of the casing of the regenerative system through the first shell, for example by means of a respective terminal.

The second outlet for the second reaction product of the electrolyser may be in communication with the space delimited by the electrolyser and the respective first shell.

Advantageously, in this way the space delimited by the electrolyser and the respective first shell define a pressurised tank for the second reaction product, for example hydrogen.

The hydrogen may be stored, under pressure, inside the first shell without using compressors.

Preferably, the outlet of the first reaction product from the electrolyser is in communication with the outside of the respective first shell by means of the coupling head.

In this way, advantageously, the head performs both a mechanical and fluid-dynamic function contributing to the compactness of the regenerative system.

Preferably, the outlet of the second reaction product of the electrolyser is in communication with the outside and/or with the inside of the respective first shell by means of the coupling head.

In this way, advantageously, the head performs both a mechanical and fluid-dynamic function contributing to the compactness of the regenerative system.

Preferably, the regenerative system comprises at least one gas sensor inserted in the space between the electrolyser and the respective first shell.

Advantageously, the sensor can monitor the purity of the inert gas present; if the gas is no longer pure, a leak from the electrolyser may be assumed and an alarm or intervention system activated until even the stopping of the system, for example to protect apparatuses downstream.

According to an aspect, the invention relates to a method for managing a regenerative system according to any one of the preceding possibilities.

The method comprises filling the space between the electrolyser and the respective first shell with the inert gas.

The method comprises pressurising the space between the electrolyser and the respective first shell.

Preferably, the management method comprises filling the space between the electrolyser and the respective first shell with the second reaction product of the electrolyser.

Further features and advantages of the above-mentioned aspects are more apparent in the non-limiting description which follows of a preferred, non-limiting embodiment of a regenerative fuel cell system.

### BRIEF DESCRIPTION OF THE DRAWINGS

The description is set out below with reference to the accompanying drawings which are provided solely for purposes of illustration without restricting the scope of the invention and in which:

FIG. 1 is a schematic perspective view of a regenerative system according to the invention;

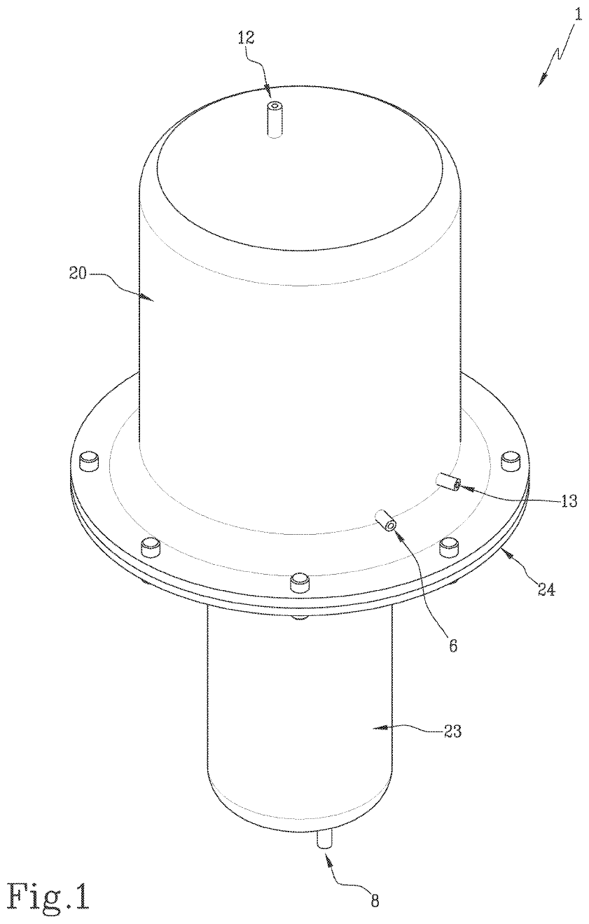

FIG. 2 is a schematic, exploded perspective view of the regenerative system of FIG. 1;

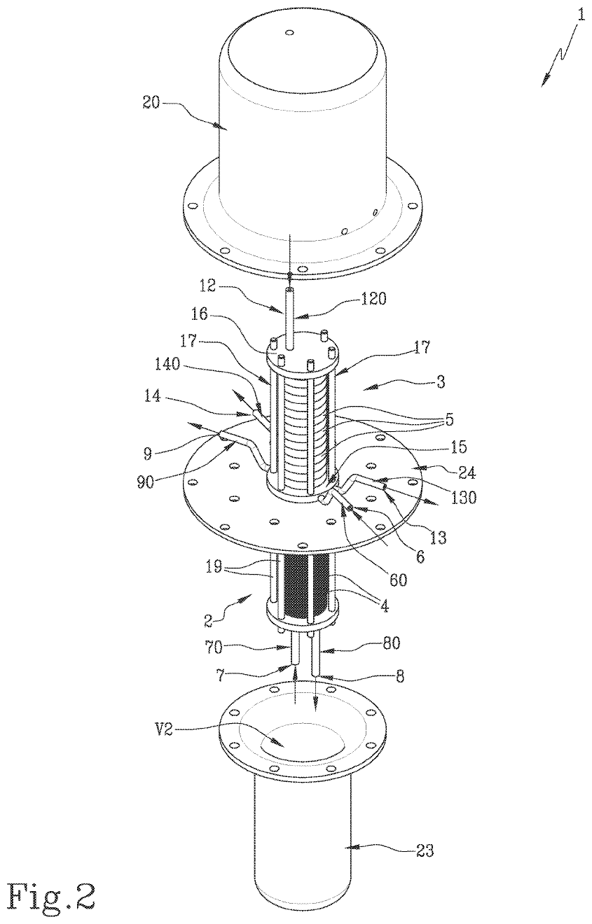

FIG. 3 is a schematic cross section of the regenerative system of FIG. 1.

### DETAILED DESCRIPTION OF PREFERRED EMBODIMENTS OF THE INVENTION

With reference to the accompanying drawings, the numeral 1 denotes a regenerative system according to the invention.

The regenerative system 1 comprises a fuel cell 2 and an electrolyser 3 of substantially known type.

The fuel cell 2 comprises a plurality of individual fuel cells 4, or stack of fuel cells 4, stacked and connected in series to each other.

Schematically, the anode of a cell 4 is connected to the cathode of the adjacent cell and the electrodes of each cell are separated by an ion conducting electrolyte.

The electrolyser 3 comprises a plurality of electrolysis cells 5, or stack of electrolysis cells, connected in series to each other for generating gas by the splitting of the water (for simplicity reference is made to water even if, in known manner, an electrolyte is used in the electrolysers).

Preferably, the fuel cell 2 and the electrolyser 3 are of the ion exchange membrane type (PEM or AEM).

Schematically, each single electrolysis cell 5 inside the electrolyser 3 operates through an electrochemical reaction wherein the water is split into hydrogen and oxygen. The anode (positive pole) of the electrolysis cell 5 is where the oxidation occurs, whilst the cathode (negative pole) is the place in which the reduction occurs. The ions move through the electrically conductive electrolyte from one electrode to another and the chemical reaction occurs at the interface between the electrodes and the electrolyte.

The fuel cell 2 has an anode side, a cathode side, an inlet 6 for a fuel, preferably hydrogen, and an inlet 7 for an oxidiser, preferably oxygen.

In the example illustrated, the fuel cell 2 is of the counter-current type, to which reference will be made without thereby limiting the scope of the invention; however, further and different embodiments, substantially known and not illustrated, are possible.

In a substantially known manner, the fuel cell 2 comprises an outlet 8 for any exhaust gas on the anode side, for example fuel which has not reacted and which may be recirculated.

In substantially known manner, the fuel cell 2 comprises an outlet 9 for any outlet gas on the cathode side, for example oxygen which has not reacted or gas rich in nitrogen.

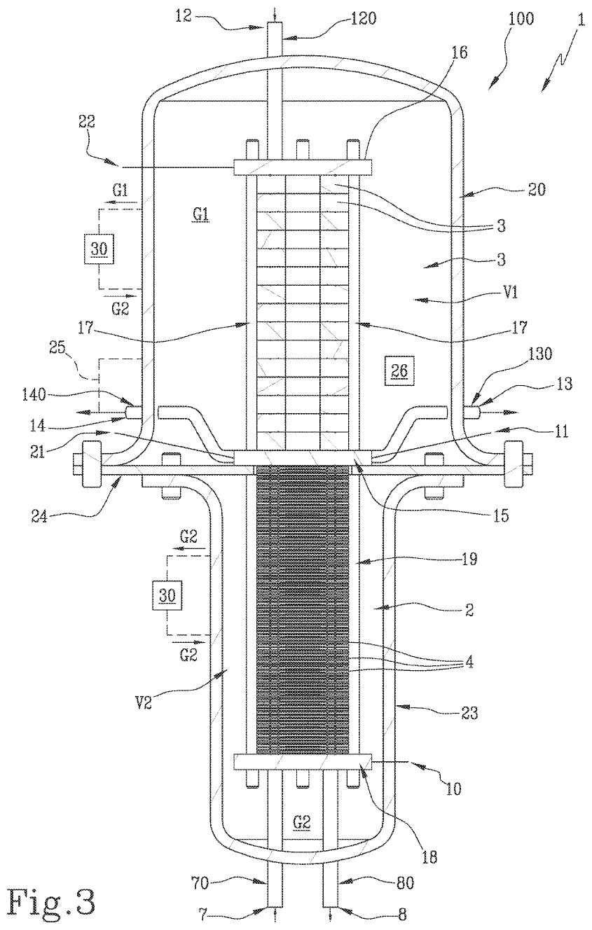

FIG. 3 schematically shows a terminal 10 in communication with the anode terminal of the fuel cell 2 and a terminal 11 in communication with the cathode of the fuel cell 2. For simplicity, reference is also made below to the terminals 10, 11 to mean the anode and the cathode of the fuel cell 2.

The electrolyser 3 comprises an anode, a cathode, an inlet 12 for an electrolyte, an outlet 13 for a first reaction product, for example oxygen, an outlet 14 for a second reaction product, for example hydrogen.

FIG. 3 schematically illustrates a terminal 21 in communication with the anode terminal of the electrolyser 3 and a terminal 22 in communication with the cathode terminal of the electrolyser 3. For simplicity, reference is also made below to the terminals 21, 22 to mean the anode and the cathode of the electrolyser 3.

The regenerative system 1 comprises a coupling head 15 interposed between the fuel cell 2 and the electrolyser 3.

The head 15 is in common with the two stacks of fuel cells and electrolysis cells and keeps them separated at least fluid dynamically.

The fuel cell 2 and the electrolyser 3 are coupled to the head 15 on opposite sides of it.

The electrolysis device 3 comprises a head 16 positioned on the opposite side of the head 15 with respect to the individual electrolysis cells 5.

The head 15 and the head 16 are connected, for example, by threaded bars 17, electrically insulated, for the assembly and compaction of the electrolyser 3.

The fuel cell 2 comprises a head 18 positioned on the opposite side of the head 15 with respect to the individual fuel cells 4.

The head 15 and the head 18 are connected, for example, by threaded bars 19, electrically insulated, for an assembly and the compaction of the fuel cell 2.

The regenerative system comprises a first shell 20 inside of which the electrolyser 3 is inserted.

As illustrated, the outlet 13 of the first reaction product of the electrolyser 3 is in communication with the outside of the first shell 20 by means of the head 15.

The outlet 13 of the first reaction product of the electrolyser 3 is in communication with the outside of the first shell 20 through the first shell 20, for example by a conduit 130 passing through the first shell 20.

As illustrated, the outlet 14 of the second reaction product of the electrolyser 3 is in communication with the outside of the first shell 20 by means of the head 15.

The outlet 14 of the second reaction product of the electrolyser 3 is in communication with the outside of the first shell 20 through the first shell 20, for example by a conduit 140 passing through the first shell 20.

As illustrated, the inlet 6 for the fuel of the fuel cell 2 is in communication with the cell through the head 15.

As illustrated, the outlet 9 of the fuel cell 2 is in communication with the stack of cells through the head 15.

The anode 21, the cathode 22, the inlet 12 of the electrolyte and the outlet 13 of the first reaction product and the outlet 14 of the second reaction product are illustrated in communication with the outside of the first shell 20.

The inlet 12 of the electrolyte is in communication with the outside of the first shell 20 through the first shell 20, for example by means of a conduit 120.

The outlet 14 of the second reaction product is in communication with the outside of the first shell 20 through the first shell 20, for example by means of a conduit 140.

The first shell 20 is closed in a sealed fashion around the electrolyser 3 in such a way as to delimit at least partly, with the electrolyser 3, a space V1 containing a gas G1, preferably inert and preferably under pressure, for example nitrogen.

The pressure of the gas G1 in the space V1 is greater than the pressure at which the electrolyser 3 operates.

The pressure of the gas G1 in the space V1 is, for example, greater than 60 bar.

According to an embodiment, the pressure of the gas G1 in the space V1 is less than the pressure at which the electrolyser 3 operates.

According to the example illustrated, the regenerative system 1 comprises a second shell 23 in which the fuel cell 2 is inserted.

The anode 10, the cathode 11, the inlet 6 and the inlet 7 are in communication with the outside of the second shell 23.

The inlet 7 of the oxidiser is in communication with the outside of the second shell 23 through the second shell 23, for example by means of a conduit 70.

The outlet 8 is in communication with the outside of the second shell 23 through the second shell 23, for example by means of a conduit 80.

The second shell 23 is closed in a sealed fashion around the fuel cell 2 in such a way that a space V2 is delimited, at least partly, between the second shell 23 and the fuel cell 2.

The regenerative system 1 comprises a gas G2 in the space V2, preferably inert, preferably under pressure, for example nitrogen.

According to an embodiment, the pressure of the gas G2 in the space V2 is greater than the pressure at which the fuel cell 2 operates.

According to an embodiment, the pressure of the gas G2 in the space V2 is less than the pressure at which the fuel cell 2 operates.

According to an embodiment, the regenerative system 1 comprises a system for recirculating gas G1 and/or gas G2 schematically illustrated with a dashed line and labelled 30 in FIG. 3.

According to an embodiment, the hydrogen produced by the electrolyser 3 is used as a fuel in the anode side of the fuel cell 2.

According to the embodiment illustrated, the regenerative system 1 comprises a flange 24 located between the electrolyser 3 and the fuel cell 2.

The first shell 20 is fixed in a sealed fashion on the flange 24 for example by interposing a gasket not illustrated.

The second shell 23 is fixed in a sealed fashion on the flange 24 for example by interposing a gasket not illustrated.

The shell 20 and the shell 23 joined to the flange 24 define a casing 100, closed in a sealed fashion, of the regenerative system 1.

According to the embodiment illustrated, the coupling head 15 between the electrolyser 3 and the fuel cell 2 is positioned inside the casing 100.

In particular, the coupling head 15 between the electrolyser 3 and the fuel cell 2 is positioned inside the first shell 20.

The coupling head 15 is located on the same side as the electrolyser 3 with respect to the flange 24.

As illustrated, the inlet 6 for the fuel of the fuel cell 2 is in communication with the cell through the head 15.

According to the example illustrated, the inlet 6 is in communication with the outside of the casing 100 through the first shell 20, for example by means of a conduit 60 passing through the first shell 20.

The outlet 9 of the fuel cell 2 is in communication with the stack of cells through the head 15.

The outlet 9 is in communication with the outside of the casing 100 through the first shell 20, for example by means of a conduit 90 passing through the first shell 20.

The cathode side of the fuel cell 2 is in communication with the outside of the casing 100 through the first shell 20, for example by means of the terminal 11.

According to an embodiment, shown by a dashed line, the outlet 14 is in communication with the space V1 by means of a line 25 which may be inside the space V1 or outside it.

The regenerative system 1 comprises a gas sensor, schematically represented as a block 26, inserted in the space V1.

The gas sensor 26 is configured for monitoring the purity of the gas G1.

The invention also relates to a method for managing the regenerative system 1.

The method comprises filling the space V1 with the gas G1.

The method comprises pressurising the space V1.

The method may comprise filling the space V1 with the second reaction product of the electrolyser 3.

1. A regenerative system comprising
a fuel cell (2) having an anode side, a cathode side, an inlet (6) for a fuel, an inlet (7) for an oxidiser;
an electrolyser (3) having an anode (21), a cathode (22), an inlet (12) for an electrolyte, a first outlet (13) for a first reaction product, a second outlet (14) for a second reaction product;
a coupling head (15) between the fuel cell (2) and the electrolyser (3), said regenerative system being characterised in that it comprises at least a first shell (20) in which the electrolyser (3) is inserted, said anode (21), said cathode (22), said inlet (12) for an electrolyte, said first outlet (13) for a first reaction product, being in communication with the outside of said first shell (20) through said first shell (20), said first shell (20) being closed in a sealed fashion around said electrolyser (3), a first space (V1) being delimited at least partly between said first shell (20) and said electrolyser (3), said regenerative system comprising a first gas (G1) under pressure in said first space (V1).

2. The regenerative system according to claim 1, comprising a second shell (23) in which said fuel cell (2) is inserted,
said anode side, said cathode side, said inlet (6) for a fuel, said inlet (7) for an oxidiser being in communication with the outside of said second shell (23),
said second shell (23) being closed in a sealed fashion around said fuel cell (2), a second space (V2) being delimited at least partly between said second shell (23) and said fuel cell (2).

3. The regenerative system according to claim 2, comprising a second gas (G2) in said second space (V2).

4. The regenerative system according to claim 3, wherein said second gas (G2) is under pressure.

5. The regenerative system according to any one of the preceding claims, comprising a flange (24) positioned between said electrolyser (3) and said fuel cell (2), said first shell (20) being fixed in a sealed fashion to said flange (24).

6. The regenerative system according to any of claims 2 to 4, comprising a flange (24) positioned between said electrolyser (3) and said fuel cell (2), said first shell (20) and said second shell (23) being fixed in a sealed fashion to said flange (24).

7. The regenerative system according to any one of the preceding claims, wherein said second outlet (14) for a second reaction product is in communication with said first space (V1).

8. The regenerative system according to any one of the preceding claims, wherein said first outlet (13) for a first reaction product is in communication with the outside of said first shell (20) by means of said coupling head (15).

9. The regenerative system according to any one of the preceding claims, wherein said second outlet (14) for a second reaction product is in communication with the outside or with the inside of said first shell (20) by means of said coupling head (15).

10. The regenerative system according to any one of the preceding claims, wherein said first gas (G1) comprises said second reaction product.

11. The regenerative system according to any one of the preceding claims, wherein said first gas (G1) in said first space (V1) has a pressure greater than an operating pressure of the electrolyser (3).

12. The regenerative system according to any one of the preceding claims, wherein said first gas (G1) in said first space (V1) has a pressure greater than 60 bar.

13. The regenerative system according to any one of claims 1 to 10, wherein said first gas (G1) in said first space (V1) has a pressure greater than an operating pressure of the electrolyser (3).

14. The regenerative system according to any one of the preceding claims, comprising a gas sensor (26) inserted in said first space (V1).

15. The regenerative system according to claim 5 or 6, wherein said coupling head (15) is positioned inside said first shell (20) on the same side of the electrolyser (3) with respect to said flange (24).

16. The regenerative system according to claim 2, wherein said first shell (20) and said second shell (23) define a closed casing (100).

17. The regenerative system according to claim 16, wherein said inlet (6) for a fuel is in communication with the outside of said casing (100) through said first shell (20).

18. The regenerative system according to claim 16 or 17, wherein the cathode side of said fuel cell (2) is in communication with the outside of said casing (100) through said first shell (20).

19. The regenerative system according to any one of claims 16 to 18, wherein the fuel cell (2) comprises an outlet (9) for any exhaust gas on the cathode side in communication with the outside of said casing (100) through said first shell (20).

20. The regenerative system according to claim 2, wherein the fuel cell (2) comprises an inlet (7) for an oxidiser and/or an outlet (8) for any exhaust gas on the anode side in communication with the outside of said second shell (23) through said second shell (23).

21. A method for managing a regenerative system according to any one of the preceding claims, comprising filling the first space (V1) with the first gas (G1), pressurising the first space (V1).

22. The management method according to claim 21, comprising filling the first space (V1) with the second reaction product of the electrolyser (3).
